(19) United States
(12) Patent Application Publication
(10) Pub. No.: US 2017/0129082 A1
(43) Pub. Date: May 11, 2017

(54) Device For Removal of Broken Plug

(71) Applicant: Michael Frankovic, Downers Grove, IL (US)

(72) Inventor: Michael Frankovic, Downers Grove, IL (US)

(21) Appl. No.: 15/203,540

(22) Filed: Jul. 6, 2016

Related U.S. Application Data
(60) Provisional application No. 62/188,978, filed on Jul. 6, 2015.

(51) Int. Cl. B25B 27/02

(52) U.S. Cl. CPC B25B 27/02

(57) ABSTRACT

A tool is provided for the effective removal of a broken plug from within a jack of an electronic device. The tool can have two handles at a base end that a user squeezes together to grip objects within a jaw portion located at a distal end. The jaw portion of the tool is sized and shaped to be able to be inserted inside a typical jack, such as an industry standard 3.5 mm headphone jack. The jaw portion can be part of the tool or can be provided by bits that are fit onto the tool. An alternate embodiment tool uses a screw and nut assembly on a “T” shaped cylindrical tool that clamps jaw members together as the screw and nut are tightened.

This application claims the benefit of U.S. Provisional Application 62/188,978, filed Jul. 6, 2015.

### BACKGROUND

1. Field

This disclosure is generally related to audio, video, and computer devices with industry standard 3.5 mm TRRS stereo audio jacks. While these jacks are known to provide audio to headphones and cables, video can also be transmitted through the jack. The disclosure relates to a repair tool for audio, video and computer devices associated with jacks and plugs.

2. Description of the Related Art

Due to circumstances, there will be incidents where headphone connectors and plugs inside 3.5 mm jacks will be broken, and a remnant of the headphone or cable jack will retained inside the audio jack. This condition can cause issues with the device, including but not limited to: audio no longer working on the device, the headphone jack being unusable with replacement headphones and audio cables, unusable telephone devices, and other unspecified issues.

Removal of broken plug material without damaging the jack is important for the continued proper use of the device. The volume within the device associated with the jack is very constrained. Additionally, the proper working of a headphone jack usually requires a tight fit and snug connection of the plug to the inside wall or contacts of the jack. Removal of a damaged plug is difficult considering the broken pieces are inside a very small and deep volume. The broken plug is not being easily removed by gravity or small nudge or tap. The present inventor has recognized that the plug should be gripped securely, and pulled with some force to be removed from inside the headphone jack.

### SUMMARY

The embodiments of the invention provide a tool for the effective removal of a broken plug from within a jack of an electronic device.

A first embodiment tool is in the general form of a pair of pliers. The tool includes two handles at a base end that a user squeezes together to grip objects within a jaw portion located at a distal end. The jaw portion of the tool is sized and shaped to be able to be inserted inside a typical jack, such as an industry standard 3.5 mm headphone jack. The jaw portion is cylindrical in transverse shape and divided into two jaw members across a parting plane across the middle of the tool's circumference. Additionally, the jaw members have concave inside surfaces which allow the jaw to fit and grip securely and snugly a circular object within a circular jack. Gripping ridges or teeth on the inside surfaces of the jaw members allows additional grip and adhesion to the object. Handles can be spring loaded and have a small amount of opening movement, given the confined sizes and volume within the jack. The outside surface of the jaw portion is smooth to prevent damage or abrasion to an inside of the device's jack when using the tool.

The tool can be sized to fit easily into an industry standard 3.5 mm TRRS stereo headphone jack, with the jaw portion of the tool being split longitudinally into even semi-circles. Each jaw member has a concave interior allowing the tool to surround a rounded circular object inside of a jack. By clamping of both jaw members of the tool, along with the gripping teeth, an object can be gripped effectively and removed from the jack.

An alternate embodiment tool uses a screw and nut assembly on a “T” shaped cylindrical tool that clamps jaw members together as the screw and nut are tightened. The jaw members are connected at a base end to a handle portion. The screw and nut are located along the jaw members spaced form the handle portion. Tightening of the screw causes the jaw members to either flex or pivot, causing the jaw members to clamp together and form a solid grip and connection to an object inside the jack. The tool and the object can then be retracted from the jack to extricate the object.

A further alternate embodiment incorporates a plier like tool having clamps on each end of the gripping arms to hold the shank of specialty bits. The bits are formed to have jaw portions on the distal ends thereof. Each jaw portion can have a concave region with gripping teeth therein. The concave regions of opposing bits are sized to fit into a device jack to grip and thereafter remove a broken plug.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is an elevation view of a first embodiment of the plug extraction tool of the invention;

FIG. 2 is a sectional view taken generally along line 2-2 of FIG. 1 or FIG. 5;

FIG. 3 is a sectional view taken generally along line 2-2 of FIG. 1 or FIG. 5 with the tool in an open configuration;

FIG. 4 is a fragmentary sectional view taken generally along line 4-4 of FIG. 2 and FIG. 3;

FIG. 5 is an elevation view of an alternate embodiment plug extraction tool of the invention;

FIG. 6 is a sectional view of a jaw of either embodiment clamping onto a broken plug, for retraction from a jack;

FIG. 7 is an elevation view of a further embodiment plug extraction tool of the present invention;

FIG. 8 is an enlarged elevation of a bit taken from FIG. 7;

FIG. 9 is a right side view of the bit shown in FIG. 8; and

FIG. 10 is an enlarged view taken from FIG. 9.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

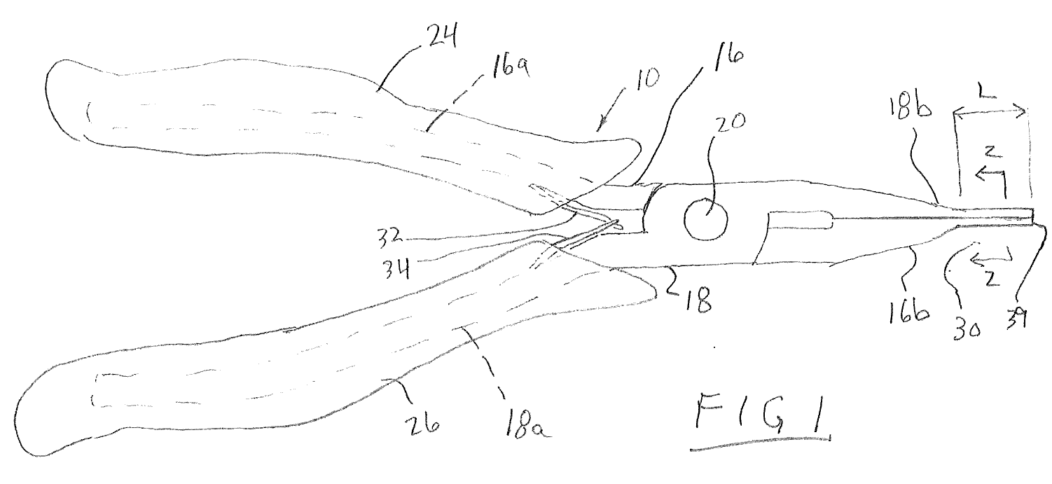

FIG. 1 illustrates a first embodiment extraction tool 10. This tool has the overall shape and operation of a pair of needle nose pliers except as noted. The tool 10 includes a first arm 16 and a second arm 18 pivotally connected along their length at a joint 20. Handles 24, 26 are fit over rear portions 16a, 18a of the arms 16, 18, respectively. Front end portions 16b, 18b of the arms 16, 18 form a jaw 30 at a distal end. The jaw has a length L. The length L can be 10 mm. Leaf springs 32, 34 connected to the arms 16, 18 urge the rear portions 16a, 118a away from each other. Squeezing the handles 24, 26 toward each other closes the jaw 30. Releasing squeezing pressure on the handles 24, 26 allows the leaf springs 32, 34 to open the jaw 30.

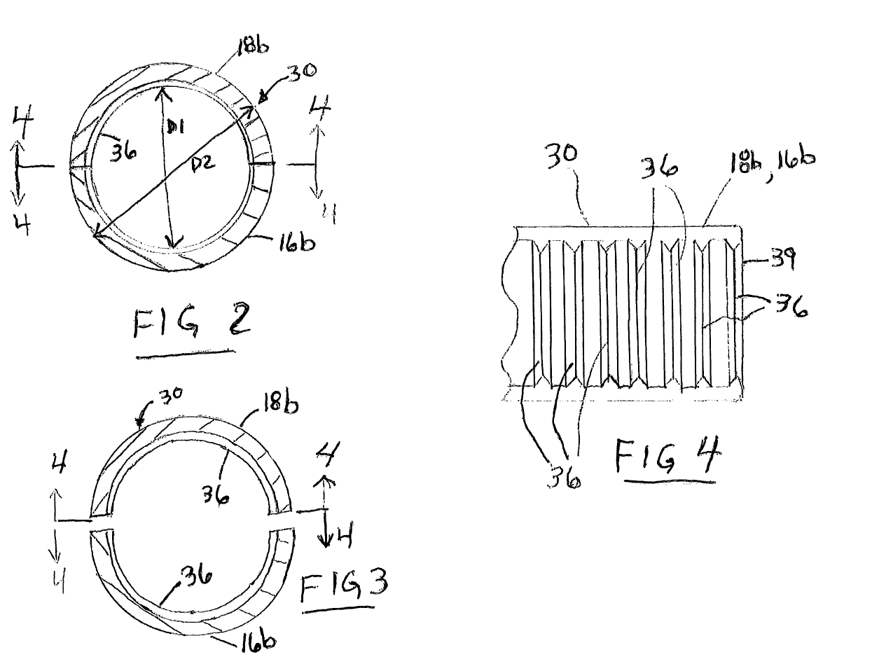

FIG. 2 illustrates the jaw 30 in a closed configuration. The front end portions 16b, 18b include spaced-apart circumferential ridges or teeth 36 that define an inside diameter of D1. D1 can be about 2.0 mm. The outside of the jaw 30 had a diameter of D2. D2 can be about 3.2 mm. Preferably the values of D1 and D2 are selected to fit within a jack of an electronic device in a slightly open condition as shown in FIG. 3, and when the jaw is closed to be able to grip or clamp onto a broken portion of a plug. These dimensions L, D1 and D2 can be adjusted for different size plugs and jacks. Once clamped onto the plug the jaw and plug can be retracted out of the jack.

FIG. 4 shows the ridges 36 extending from a front edge 39 of each arm portion 16b, 18b. The ridges are spaced apart along the length of the jaw 30. Each ridge has a triangular cross section to bite into the plug to grip the plug for extraction. Other shapes and configurations of the ridges are encompassed by the invention.

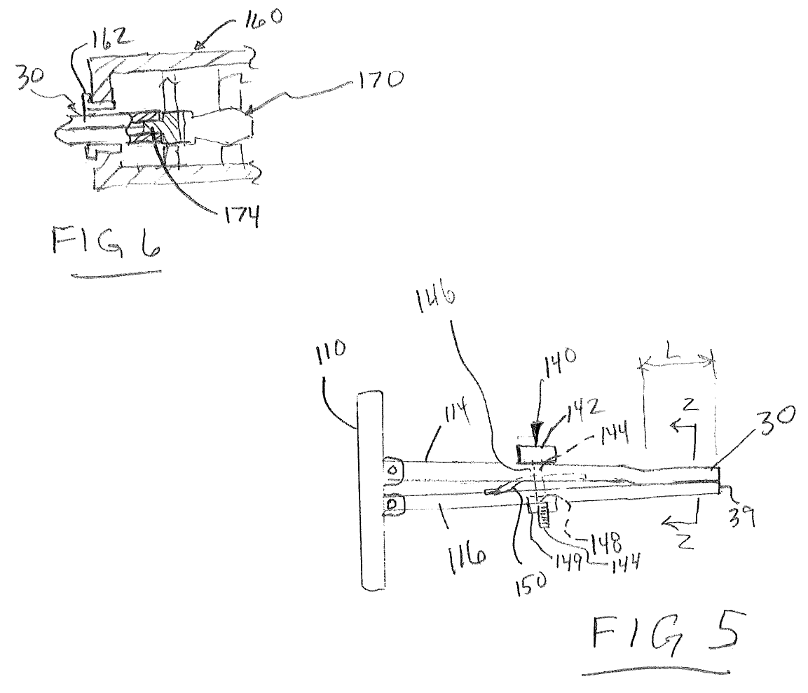

FIG. 5 illustrates an alternate embodiment tool 100. This tool includes a handle portion 110 and two arms 114, 116 pivotally connected at a base end to the handle by pins or by being inherently resiliently flexible. At distal ends, the arms form the jaw 30 which is essentially identical to the jaw 30 previously described for the tool 10. The arms are further spaced apart at base ends than distal ends. At an intermediate position between the jaw 30 and the handle 110 is a tightening screw 140 having a knurled head 142 for turning by a user. The head 142 is connected to a threaded shaft 144 that passes through a plain hole 146 in the arm 114 and is threaded into a threaded hole 148 through the arm 116. Advantageously the threaded hole 148 is formed by a nut 149 fixed on the arm 116.

A leaf spring 150 acts between the arms 114, 116 to urge the arms apart. When the screw 140 is tightened against the urging of the spring 50, the screw draws the arms 114, 116 together at the intermediate position and closes the jaw 30. When the screw is loosened, the spring 150 urges the arms apart at the intermediate position and opens the jaw 30. To remove a broken plug recessed into the jack, the jaw is slightly opened and inserted into the jack and around a broken portion of the plug. The screw 140 is then tightened to clamp the jaw 30 onto the plug. The jaw 30 with the broken plug are then extracted from the jack.

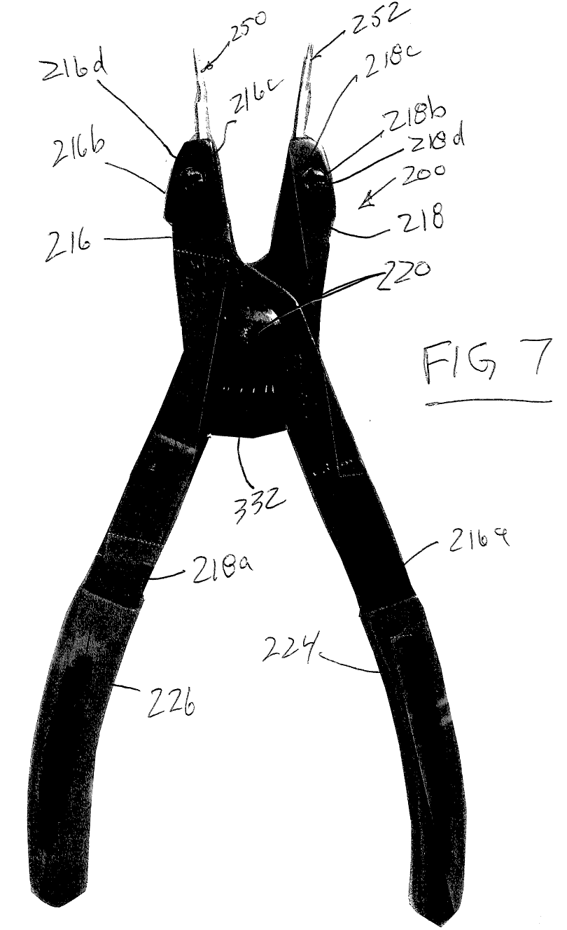

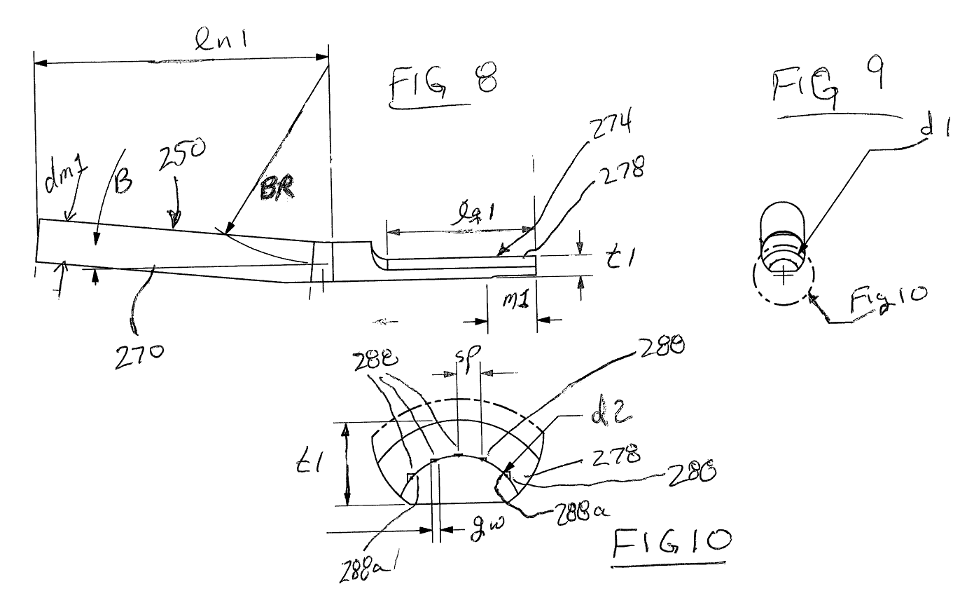

FIG. 6 shows an electronic device 160 having a jack 162. A plug 170 has been inserted into the jack. The last contact cylinder of the plug is missing, as being broken off, and a cylindrical stub 174 remains, recessed into the device 160. Either of the prior described tools 10, 100 can be used to extract the plug by inserting the respective jaw 30 into the jack and clamping the stub 174 by either squeezing the arms 24, 26 together or by tightening the screw 140. The jaw 30 is shown partly in section to show gripping of the jaw 30 onto the stub 174. The jaw 30 is then retracted to extract the plug 170 from the device 160 through the jack 162.

The ridges 36 grip the plug stub 174 with a high degree of friction to prevent slipping between the jaw 30 and the plug 170.

FIGS. 7-10 illustrates a third embodiment extraction tool 200. This tool has the overall shape and operation of a pair of retaining ring or circlip pliers except as noted. A retaining ring or circlip pliers having bit clamping mechanisms are described for example in U.S. Pat. No. 4,790,056, herein incorporated by reference. The tool 200 includes a first arm 216 and a second arm 218 pivotally connected along their length at a joint 220. Handles 224, 226 are fit over rear portions 216a, 218a of the arms 216, 218, respectively. Front end portions 216b, 218b of the arms 216, 218 include clamps 216c, 218c at distal ends. A coil spring 332 connected to the arms 16, 18 urge the rear portions 216a, 218a away from each other and the front portions 216b, 218b away from each other. Squeezing the handles 224, 226 toward each other closes front portions 216b, 218b. Releasing squeezing pressure on the handles 224, 226 allows the coil springs 332 to open the front portions 216b, 218b.

Each clamp 216c, 218c holds an extraction bit or tool part 250, 252 respectively. The bits are identical. The bits are placed into an open clamp 216c, 218c and a respective screw 216d, 218d is tightened to clamp the respective bit 250, 252.

The bits are described in FIGS. 8-10. Since the bits 250, 252 are identical, only the bit 250 will be described. The bit includes a shank 270 having a diameter dm1 of about 0.109 inches and a length In1 of about 0.75 inches and arranged to be clamped into the clamp 216c by the screw 216d. The shank can be bent or curved at an angle B of about 6 degrees with a bend radius BR if about 0.5 inch, to a jaw portion 274. The purpose of the bend or curve is to allows the opposing jaw portions of the two bits 250, 252 to assume a somewhat parallel orientation when the handles 224, 226 are squeezed together to allow the jaw portions to fit into a socket to remove a broken plug. The jaw portion has a reduced overall thickness of t1 compared to the shank 270. The thickness t1 can be 0.053 inches. The purpose of the reduced thickness is to allow opposing jaw portions to be fit into a socket to remove a broken plug.

Each jaw portion 274 has a length Ig1 of about 0.375 to 0.5 inches and a concave end region 278 that is semi-annular with a length m1. According to the illustrated embodiment the length m1 is about 0.125 inches. The region 278 has an outer diameter d1 of about 0.125 inches and an inner diameter d3 of about 0.080 inches.

As shown in FIG. 10, on an inside of the region 278, a series of spaced apart longitudinal grooves 288 are cut along an inside surface of the region 278. The grooves each have a width gw of about 0.005 inches and extend along the region 278 for substantially the length m1. The grooves are rectangular and are cut in a parallel orientation at a spacing sp of about 0.015 inches.

The grooves 288 are cut into the semicircular inside surface of the region 278 to a sufficient depth to form sharp edges 288a along the edges of each groove which act as teeth to grip the broken plug to be removed.

When the handles 224, 226 are squeezed toward each other and the jaw portions 274 are brought in substantial parallel orientation, the regions 278 have an over diameter of about 0.125 inches. Preferably, the values of t1, m1, d1 and d2 are selected for the opposing jaw portions 274 to fit within a jack of an electronic device in a slightly open condition (such as shown in FIG. 3), and when the jaw portions are closed together, the end regions 278 are able to grip or clamp onto a broken portion of a plug. These dimensions t1, m1, d1 and d2 can be adjusted for different size plugs and jacks. Once clamped onto the plug by squeezing the handles 224, 226, the jaw portions 274 and plug can be retracted out of the jack.

From the foregoing, it will be observed that numerous variations and modifications may be effected without departing from the spirit and scope of the invention. It is to be understood that no limitation with respect to the specific apparatus illustrated herein is intended or should be inferred.

All references, including publications, patent applications, and patents, cited herein are hereby incorporated by reference to the same extent as if each reference were individually and specifically indicated to be incorporated by reference and were set forth in its entirety herein, to the extent that the references are not inconsistent with the present disclosure.

The invention claimed is:

1. A pliers-like tool with a jaw portion that has a cylindrical outside surface with a longitudinal parting plane, and having curved inside surfaces on opposite sides of the parting plane, the inside surfaces having gripping formations.

2. The tool according to claim 1, wherein the cylindrical outside surface and the curved inside surfaces are sized to allow the tool to fit into a circular shaped area and allow the tool to surround and grip round items in a confined volume.

3. The tool according to claim 1, wherein the inside surfaces are curved smoothly around circular shaped objects of similar size, and the gripping formations comprise circumferential teeth.

4. The tool according to claim 1, wherein the outside diameter of the jaw portion is less than 3.4 millimeters in width, and less than 11 mm in length.

5. The tool according to claim 1, wherein the outside diameter of the jaw portion is about 3.2 mm, the inside diameter is about 2 mm and the length is about 10 mm.

6. The tool according to claim 1, wherein the inside surfaces are rounded semi circles and the gripping formations comprise circumferential teeth.

7. The tool according to claim 1, wherein the jaw portion is formed by bits that are separable from the remaining portions of the tool.

8. The tool according to claim 7, wherein the bits each comprise a shank portion and a jaw portion, and the jaw portion includes a concave region that provides the curved inside surface, and the gripping formation is formed by longitudinal grooves in the concave region.

9. The tool according to claim 8, wherein the shank portion is angled from the jaw portion.

10. A broken plug extraction tool for removing a broken plug from a jack, comprising:
a base end having a handle portion;
arm members connected at the base end to the handle portion and having jaw portions at a distal end;
a screw and nut located between along the arm members between the handle and the jaw portions, the screw engaged to one arm member and the nut engaged to the respective other arm member;
tightening of the screw into the nut causes the arm members to either flex or pivot, causing the jaw portions to clamp together and form a solid grip and connection to an broken plug inside the jack.
